(19) United States
(12) Patent Application Publication
(10) Pub. No.: US 2004/0202841 A1
(43) Pub. Date: Oct. 14, 2004

(54) Double-faced adhesive tape with no release paper

(75) Inventor: David Jour, Taipei (TW)

Correspondence Address: BACON & THOMAS, PLLC, 625 SLATERS LANE, FOURTH FLOOR, ALEXANDRIA, VA, 22314

(73) Assignee: KUDOS FINDER TRADING CO., LTD., Taipei (TW)

(21) Appl. No.: 10/298,595

(22) Filed: Nov. 19, 2002

(51) Int. Cl. B32B 3/00

(52) U.S. Cl. 428/195.1; 428/194

(57) ABSTRACT

This invention concerns a novel double-faced adhesive tape with no release paper, wherein a long stripe of paper is coated both on the front face and the back face with the adhesive glue and release paper at an equidistant interval, and the adhesive tape so manufactured is capable of adhering two material on the front face and the back face without bother to tear off the release paper. The double-faced adhesive tape is supported in a holder with a reel to hold it in place. The holder provides a saw-teeth cutter convenient for cutting off the adhesive paper.

### FIELD OF THE INVENTION

This invention relates to a structural improvement in the double-faced adhesive tape with no release paper.

### BACKGROUND OF THE INVENTION

It is well known that the prior art of the adhesive tape mainly comprises a fixed size of paper or plastic tape with one face coated with adhesive glue and covered with a layer of release paper. When using it, the user has to tear off the release paper, and apply the adhesive face to the material he wants to adhere.

Tearing off the release paper from the adhesive tape is sometimes an apparent inconvenience and quite a hardship. Furthermore, an additional release paper applied means an additional production cost. There leaves more room for improvement.

Viewing from above-mentioned inconvenience and hardship, the inventor has exerted great efforts for years to the improvement and finally came up this invention.

### SUMMARY OF THE INVENTION

The major object of the invention is to provide a kind of adhesive tape without applying a layer of release paper, saving trouble to tear it off while in use. It is reusable even with no release paper covered.

This invention is explained in great details with the aid of preferable embodiments as illustrated in the drawings attached.

### BRIEF DESCRIPTION OF THE DRAWINGS

FIG. 1 is a stereo of the adhesive tape with a holder of this invention.

FIG. 2 is a side view of the adhesive tape with a holder of this invention.

### DETAILED DESCRIPTION OF THE INVENTION

As shown in the attached drawings, the double-faced adhesive tape with no release paper provided in this invention mainly concerns a reel of adhesive tape 1.

The prior art of the double-faced adhesive tape 1 commonly used has one layer of release paper 20 to cover each of the adhesive glue 30. While in use, the release paper 20 has to be tom off first to expose the adhesive glue 30 to be attached to the material.

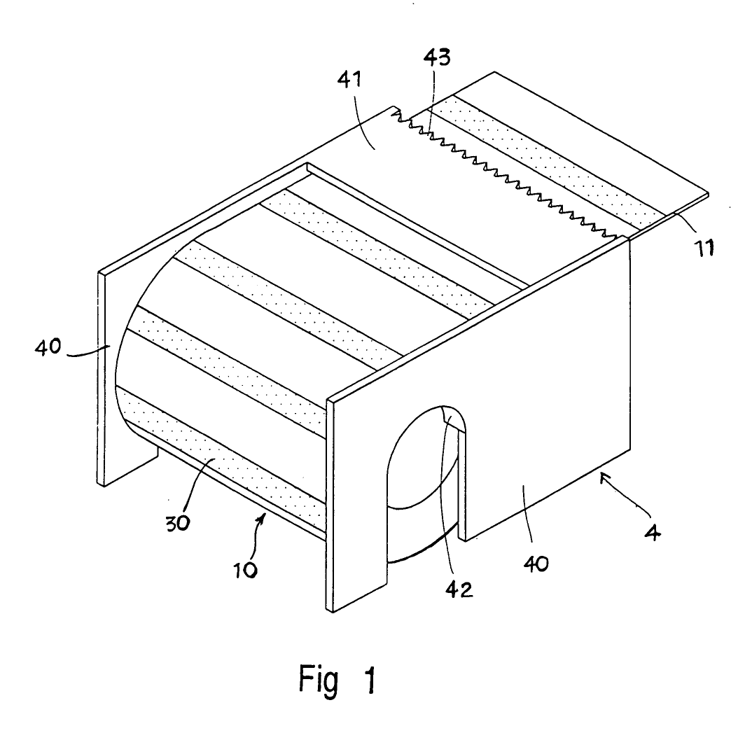

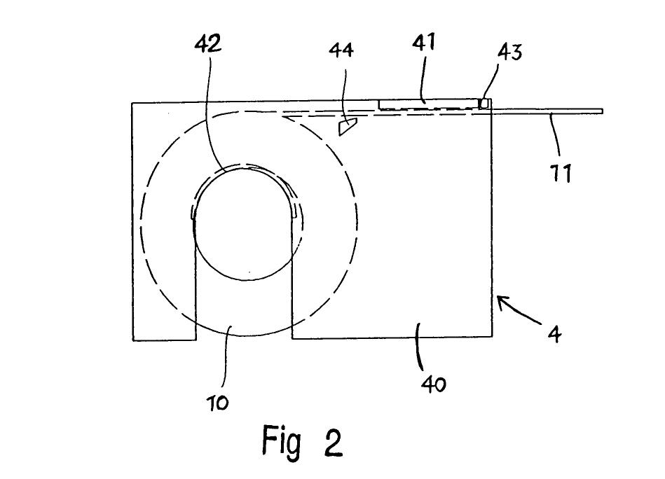

As shown in FIGS. 1 and 2, the double-faced adhesive tape is wound on a reel 10 coated on both faces by the automatic coating process with a section of adhesive glue 30 and a section of separating blank at an equal spaced interval. The reel 10 of the adhesive tape 1 is mounted on the holder 4, convenient for the user to pull out a fixed length of the adhesive tape and cut it off at the cutter as the user desires.

The holder 4 has two walls 40 on both faces and transverse board 41 on the top.

The reel 10 wound with the adhesive tape 1 is held between two walls 40 and hanged on the fixing lug 42. The transverse board 41 is installed with a saw-teeth cutter 43 at the front tip. There is a guide roller 44 under the transverse board 41. When the reel 10 of the adhesive tape 1 is mounted on the holder 4 and the fixing lug 42 sandwiched between two walls 40, a lead section 11 of the adhesive tape 1 will be pulled out and pass the guide roller 44 and the cutter 43, easy for the user to pull it out and cut it at a fixed section of length.

The predominant advantages are that the adhesive tape 1 has only one face with the adhesive glue 30, but no release paper 20, convenient for the user to pull out at any length he wishes. The user may cut it and attach it to any material he intends with no bother to tear off the release paper 20. It therefore reduces the production cost to a great extent. The adhesive tape 1 is coated with a separating blank on both faces and wound on the reel 10, any damage occurred in one section will never spread to other section of the adhesive tape 1 on the reel 10. The adhesive tape 1 of this invention is reusable. The separating blank section provides a buffer to absorb the excessive glue coated and dispersed so as to make the adhesive tape 1 attached to the material with very smooth and flat surface.

The above statement indicates it is a fact that the adhesive tape of this invention is a breakthrough in technique, theory and experience. No similar product has ever appeared on the market. It is really a novel improvement, justified for a favorable grant of a new patent.

1. A double-faced adhesive tape with no release paper, comprising a reel of adhesive tape mounted on a holder, characterized in that said adhesive tape is coated with sections of adhesive glue and corresponding sections of separating blank on both faces, said separating blanks aligning with adhesive sections on opposite faces of the tape, by an automatic coating process, convenient for users to use and reuse.

2. The double-faced adhesive tape of claim 1, wherein said reel of said adhesive tape is held in said holder, between two walls, hanged on a fixing lug and under a transverse board.

3. The double-faced adhesive tape of claims 1 or 2, wherein said transverse board fits a saw-teeth cutter at a tip, easy for cutting off said adhesive tape at any length.
